(19) United States
(12) Patent Application Publication
(10) Pub. No.: US 2008/0180414 A1
(43) Pub. Date: Jul. 31, 2008

(54) METHOD AND APPARATUS FOR CONTROLLING LIGHT EMITTING DIODE

(76) Inventors: Kai Ming Fung, Hong Kong (HK); Chin Tung Derek Lau, Hong Kong (HK); Che Chung Roy Li, Hong Kong (HK); Chong Yiu Dennis Lui, Hong Kong (HK)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/668,472

(22) Filed: Jan. 30, 2007

(51) Int. Cl. G06F 3/038; G09G 3/32

(52) U.S. Cl. 345/204; 345/82

(57) ABSTRACT

A method of driving an LED includes determining an operational parameter of the LED, determining a driving signal parameter for the LED, and generating a periodic driving signal for driving the LED. The generated periodic driving signal has a duty cycle that depends on the determined driving signal parameter and the determined operational parameter of the LED.

### BACKGROUND OF THE INVENTION

The present invention relates to the field of illumination control, and in particular to the control of light emitting diodes.

Arrays of LEDs are increasingly employed in backlighting units (BLU) for liquid crystal displays (LCD) installed in consumer devices ranging in size from mobile phone displays to large TV screens. Whilst LEDs can provide greater control, longer life, and uniformity of light output, the LEDs used in the BLU must be tightly specified in terms of their color, brightness, forward voltage and other characteristics. These characteristics are typically specified in terms of bin values, each bin value for an LED including a limited range of characteristic values such as wavelengths, lumen, or voltages for example. Typically the BLU will be comprised of three arrays of Red, Blue, and Green LEDs, the outputs of which are mixed to generate white light for backlighting the LCD. In order to ensure uniform brightness and efficient Operation, all of the LEDs of each colored array (red, blue or green) must have the same bin values; for example the same color bin value, the same brightness bin value, and the same forward voltage bin value. This “binning” requirement is expensive to implement, especially in larger BLU, for example those used in large LCD TV screens. The uniformity of light output from the LEDs can also vary in response to changing temperature, aging and other factors, despite a constant operating current input.

It would be advantageous to have greater control over LED brightness.

### BRIEF DESCRIPTION OF THE DRAWINGS

For the purpose of illustrating the invention, there are shown in the drawings embodiments which are presently preferred. It should be understood, however, that the invention is not limited to the precise arrangements and instrumentalities shown. Elements in the figures are illustrated for simplicity and clarity and have not necessarily been drawn to scale. In the drawings:

FIG. 1 is a schematic diagram of a backlight unit (BLU) for an LCD apparatus according to an embodiment of the invention;

FIG. 2 is a schematic diagram of a driver architecture for the BLU of FIG. 1 according to an embodiment of the invention;

FIG. 3 is a schematic diagram of a driver architecture for the BLU of FIG. 1 according to another embodiment of the invention;

FIG. 4 is a schematic diagram of a driver of FIG. 2 according to an embodiment of the invention;

FIG. 5 is a schematic diagram illustrating a control interface and logic block and a PWM generator of the driver of FIG. 4 according to an embodiment of the invention; and

FIG. 6 is a flow chart illustrating a method of driving an array of LEDs according to an embodiment of the invention.

### DETAILED DESCRIPTION OF EMBODIMENTS OF THE INVENTION

In general terms in one aspect, the present invention provides a driver architecture for driving an array of (e.g., red, blue, green, or white) LEDs, the array of LEDs being arranged into a plurality of regional arrays of LEDs having one or more common LED operational parameters such as the same bin values for color, brightness, and/or forward voltage. The driver is arranged to determine a driving signal parameter for each regional array of LEDs, and which typically corresponds to the duty cycle of a PWM signal required to illuminate the LEDs to a nominal wanted brightness level. The driving signal parameter for each region may be different in order to implement regional dimming for example; or they may be the same in order to implement a uniform brightness across the LED array. The driver also determines an operational parameter such as a bin value (e.g., color, brightness, and/or forward voltage) or bin value correction co-efficient for the LEDs of each regional array. The driver then generates a periodic driving signal for driving the LEDs of the regional array, the duty cycle of the periodic driving signal (for example pulse width modulated signal—PWM) is controlled by the driver and is dependent on the determined driving signal parameter and the determined LED operation parameter for respective regional arrays.

In an embodiment of the invention, a driver architecture is configured as a master LED driver implemented within a BLU controller and coupled to a plurality of drivers, each driver coupled to drive LEDs in one of the regional arrays of LEDs. The master LED driver provides a driving signal parameter such as a duty cycle parameter of a master periodic driving signal and which corresponds to the light output required from the array of LEDs. This light output may correspond with an image being backlight on a proximate LCD, for example a reduced light output being required for a night-time scene or image on a large LCD TV screen compared with a sunny day-time scene for example.

In an embodiment of the invention, a number of driving signal parameters may be generated, one for each regional array of LEDs, in order to implement local or regional dimming. Thus, for example, if one region of the image is dark whilst another is light, a lower duty cycle can be assigned to the regional array backlighting the region of the LCD screen corresponding to the dark region of the image. Each driver is arranged to determine or receive the or its respective driving signal parameter from the master LED driver and to generate a periodic driving signal such as a pulse width modulation signal (PWM) for the LEDs which the driver is driving from the respective regional array of LEDs. The duty cycle of the generated periodic driving signal is made dependent on the determined driving signal parameter and the respective LED operational parameter for the respective regional array of LEDs. For example, in one embodiment, the driving signal parameter corresponds to a duty cycle for a master periodic driving signal and this is adjusted according to the LED operational parameter associated with the respective driver and its respective regional array of LEDs.

In an embodiment of the invention, the duty cycle of the periodic driving signal generated by a driver is also made dependent on a second determined operational parameter that corresponds to a measured temperature value associated with the LEDs driven by the driver. Thus, for example, as the temperature of the regional array of LEDs changes, the duty cycle of their driving signal is changed accordingly.

In an embodiment of the invention, the driving signal parameter comprises a clock cycle count or duration value for one of two states (for example “Logic High Voltage” or “ON”) of a notional master driving signal which is not dependent on the common operational parameter of the local or regional array of LEDs. This count or duration value may be sent from the master LED driver to the drivers using a control signal message over a serial bus. Alternatively the count or duration value may be derived from an actual master driving signal generated by the master driver and dependent on different operational parameters, such as bin values, from the operational parameters of the LEDs of one or more regional arrays of LEDs. Each driver may then be arranged to count a number of clock cycles during the one of the two states of the master driving signal, the master driving signal having a full cycle or period of a predetermined number of clock cycles.

In an embodiment of the invention, the driver has a memory that stores an operational parameter of the LED such as a bin value or bin value co-efficient dependent on the bin value; a controller arranged to determine a driving signal parameter for the LEDs such as an ON duration of a common or master PWM driving signal; and a periodic signal generator which is arranged to generate a periodic driving signal such as a PWM driving signal. In use the driver is coupled to a switch arranged to switch the LED (or string of LEDs) according to the generated periodic driving signal. The controller and periodic signal generator are arranged to adjust the duty cycle of the generated periodic driving signal dependent on the driving signal parameter and the stored operational parameter of the LED.

The duty cycle as it is used here refers to the proportion of time during one cycle (ON/OFF or HIGH/LOW for example) of a periodic signal such as a square wave (e.g., PWM) signal that the signal is in one state (eg ON/HIGH) compared with the total time or duration of the full cycle. Thus for example where the signal has equal periods of HIGH and LOW voltage (ON and OFF), the duty cycle is 50%. Where a PWM signal is ON for 300 clock cycle counts, and OFF for 100 clock cycle counts, the duty cycle is 75%. As will be appreciated by those skilled in the art, the OFF duration could be used instead of the ON duration in order to determine the duty cycle.

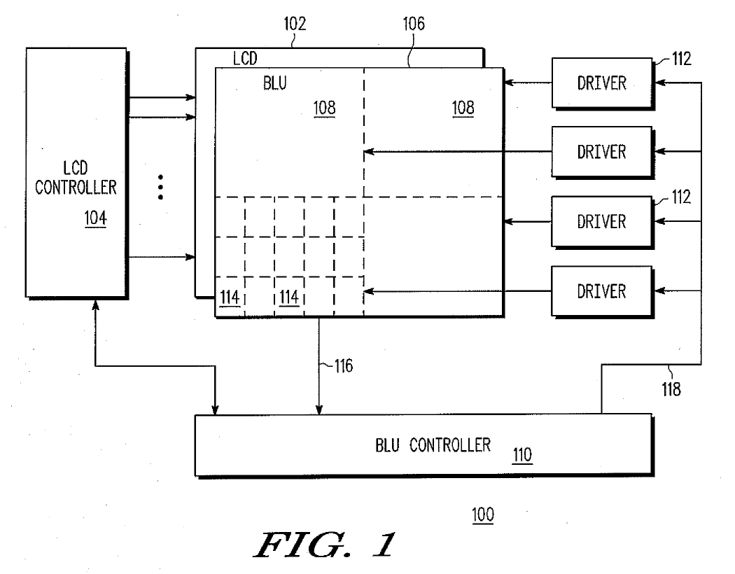

Referring now to FIG. 1, a schematic diagram of a screen apparatus 100 such as a large screen TV according to an embodiment of the invention is shown. The screen apparatus 100 comprises an LCD unit 102, an LCD controller 104, a backlight unit (BLU) 106 having a plurality of regions 108, a BLU controller 110, and a number of LED (Light Emitting Diode) drivers 112, each driving a separate one of the regions 108 of the BLU 106. Although four regions 108 are shown, the BLU 106 could have any number of regions. In addition, each region 108 could be further broken up into a plurality or areas 114. As will be understood by those of skill in the art, the LCD unit 102 comprises a plurality of pixels.

The LCD controller 104 is coupled to the LCD unit 102 and the BLU 110. The LCD controller 104 controls the pixels of the LCD unit 102 in order to form an image. The image requires backlighting, which is provided by the BLU 106, which is located behind and in correspondence with the LCD unit 102. Although the backlighting may be constant, typically it will be controlled to some extent by the LCD controller 104, for example to reduce the light output of the BLU 106 during dark images, and to increase the light output of the BLU 106 during bright images. Because the BLU 106 has been arranged into regions 108 that can be independently controlled or driven by the drivers 112, the embodiment also supports local dimming, for example when one or more of the regions 108 of the BLU 106 are instructed to change their light output compared with other ones of the regions 108. As will be appreciated, any suitable LCD unit 102 and LCD controller 104 known to those skilled in the art can be used in the embodiment.

The BLU 106 comprises a number of strings of LEDs, each driven by its own one of the LED drivers 112 or one channel of one of the LED drivers 112. Typically the BLU 106 will comprise red, blue and green LEDs, which are controlled in such a way that their light output mixes to generate white light. Alternatively different combinations or colored LEDs may be used, or a single color such as white LEDs may be used. For simplicity of explanation only one driver 112 is illustrated for each region 108 of the BLU 106. Typically however, there will be an array of LEDs in each region arranged into strings of serially connected LEDs, each driven by a single driver 112. Alternatively there may be a multi-channel driver 112, with each channel driving one or more strings of LEDs of the same or a different color as would be appreciated by those skilled in the art.

Each BLU region 108 is driven by a constant current that is controlled or switched by the respective drivers 112. Typically the constant current is switched ON and OFF by a periodic driving signal such as a PWM signal, and according to a duty cycle implemented by the driver 112. For example equal ON and OFF time is implemented by a duty cycle of 50%. The higher the duty cycle or ON time compared with the OFF time, the higher the light output from the LEDs.

Each array of LEDs within a BLU region 108 comprises LEDs (of one color) having one or more common operational parameters. These operational parameters correspond to a common range of characteristic values of a characteristic of the LEDs of the region 108. For example the range may be arranged of wavelength values of a wavelength characteristic. Typically these ranges of values are known as bin values, each bin value corresponding to a range of characteristic values such as output wavelengths. Thus different regions 108 may have different though similar bin values.

The drivers 112 each receive a driving signal parameter from the BLU controller 110, which acts as a master LED driver in this embodiment. The driving signal parameter may be a duty cycle corresponding to a master driving signal 118 from the BLU controller 110, for example the duration or number of clock cycles of the ON state or phase of the square wave of the master driving signal as described in more detail further below. The master driving signal 118 is typically a PWM signal and may be supplied directly by the BLU controller 110. The master driving signal 118 is generated by the BLU controller 110 according to brightness control commands from the LCD controller 104 as will be appreciated by those skilled in the art. Thus a legacy BLU controller may be used with the embodiment, with the duty cycle of the master driving signal 118 being modified or adjusted by each driver 112 depending on the common operational parameter of the LEDs of the BLU region 108 being driven.

As noted previously, the BLU controller 110 receives a light output control signal from the LCD controller 104 depending on the image on the LCD unit 102 to be backlit or illuminated, such as a color coordinate/brightness control message. The light output required determines the duty cycle of the master driving signal 118. The duty cycle may be adjusted according to feedback 116 received from the BLU 106 such as measurements of light output from light sensors embedded within the BLU 106 and/or embedded temperature sensors.

The driving signal parameter may be determined by each driver 112 from the master driving signal 118 received from the BLU controller 110. For example counting the clock cycles for which the master driving signal 118 is ON compared with its total period duration can be used to determine the duty cycle of the master driving signal 118, which can be used as the driving signal parameter.

Alternatively a driving signal parameter corresponding to the master driving signal 118 that would have been generated by a legacy BLU controller for example may be determined from the LCD controller 104 brightness instructions or commands. The driving signal parameter may be received directly from the LCD controller 104. Alternatively, the master driving signal 118 output from the BLU controller 110 to the drivers 112 in one embodiment may be in the form of a digital value such as a clock cycle count value for the ON duration of the master driving signal, rather than generating and outputting the signal itself. For example a serial bus such as I2C may be used to deliver the clock cycle count value or other driving signal parameter as a control signal message to each LED driver 112 on an addressable basis.

In a further alternative arrangement, the driving signal parameter received by each LED driver 112 may be different, for example to implement regional dimming. This may be implemented by providing separate master driving signals (PWM) to each respective driver 112, or a different clock cycle count value using an addressable serial bus for example. Thus one of the BLU regions 108 may be controlled by the LCD controller 104 to have a higher light output than the other BLU regions 108.

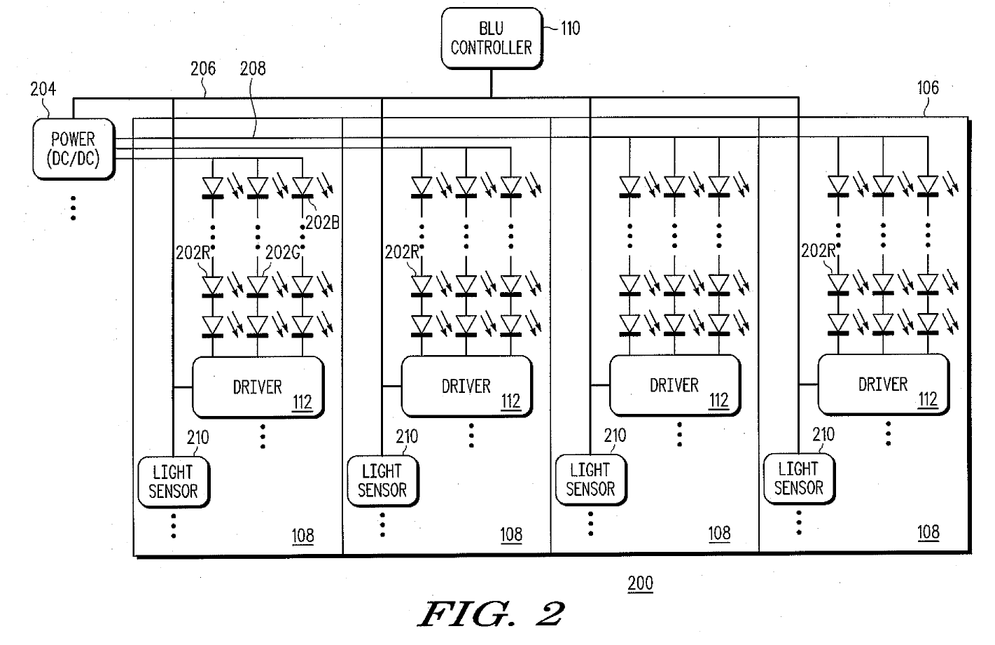

The embodiment shown in FIG. 1 is described in more detail in FIG. 2, which shows a driver architecture 200 having a master driver or BLU controller 110 coupled to a plurality of drivers 112. The drivers 112 may be implemented using a controller such as logic hardware or an embedded low cost microcontroller, each driving one or more strings of LEDs. In the embodiment shown, the strings of LEDs include blue LEDs 202B, green LEDs 202G and red LEDs 202R. A DC-DC converter 204 is independently coupled to supply each driver 112 or respective LED string, the drivers 112 being arranged to switch the supply to respective LEDs 202R, 202G and 202B (indicated collectively herein as LEDs 202). Any other suitable LED power source may alternatively be used. The BLU controller (master LED driver) 110 is coupled to the drivers 112 using a serial interface such as an I2C bus 206 that is used to address control messages to each driver 112 containing a driving signal parameter such as a duty cycle value or clock cycle count value. The DC-DC converter 204 is coupled to the drivers 112 or directly to the LEDs 202 using a power supply rail or bus 208. In this embodiment, each driver 112 controls one or more strings of red, blue and/or green LEDs 202R, 202B and/or 202G. One driver 112 is illustrated for each BLU region 108, however additional drivers may be employed for each BLU region 108.

The DC-DC converter 204 or other LED power source together with the drivers 112 are arranged to provide a constant current power supply to the LEDs 202. Each regional array of LEDs (i.e., each BLU region 108) comprises one or more strings of LEDs of each color—red 202R, blue 202B, and green 202G. As will be appreciated, using appropriate control of the light output of the LEDs of the various colors, an appropriate combined color of light output can be obtained. A light sensor 210 for each region 108 is used to feed back measured light output data from each region 108 to the BLU controller 110 via the serial bus 206. In an alternative arrangement, one light sensor 210 could be used for the entire BLU 106 but with light guide cables or other suitable light guide components to collect light output or brightness data from the different BLU regions 108.

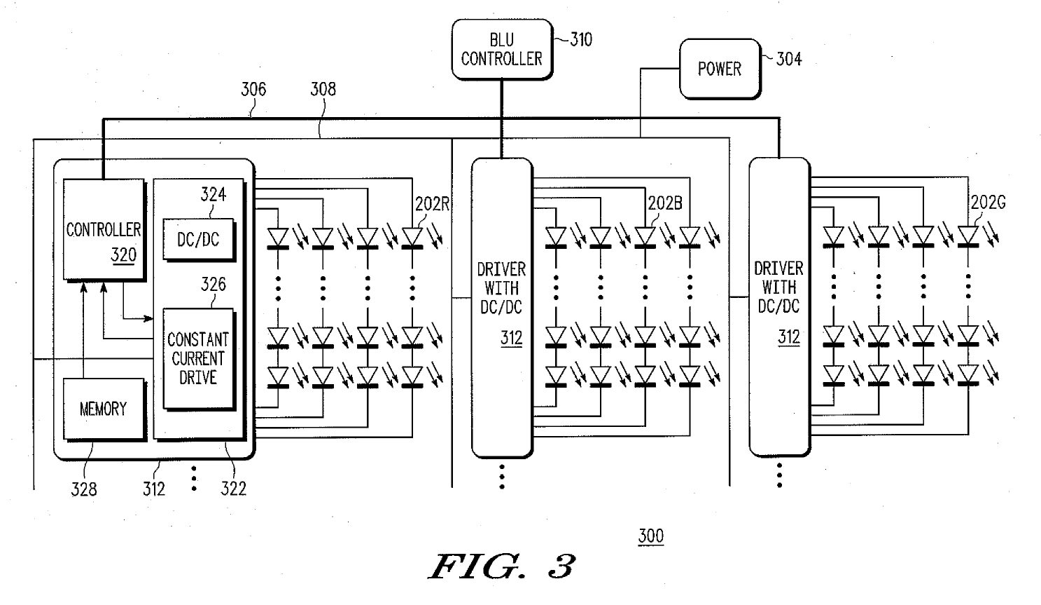

FIG. 3 illustrates an alternative embodiment driver architecture 300 including a main power source 304, a master LED driver or BLU controller 310, and a plurality of LED drivers 312, three of which are shown. Here the driver architecture 300 comprises the master LED driver or BLU controller 310 coupled to the plurality of drivers 312. The master LED driver 310 is coupled to the drivers 312 using a direct connection or signal wire 306 instead of the serial bus 206 of FIG. 2. The master LED driver 310 outputs a master PWM driving signal that is received by each of the drivers 312 over the signal wire 306. The LED drivers 312 receive power from the main power source 304 via a supply rail 308.

Each driver 312 controls one or more strings of LEDs 202R, 202G or 202B of the same color. The different colored LEDs 202R, 202G, and 202B are distributed amongst the BLU regions 108. The driving signal parameter can be determined by the drivers 312 from the master periodic or PWM driving signal. In this embodiment, the LED drivers 312 each have an integrated DC-DC converter or other LED power source. The DC-DC converter or other LED power source within each driver 312 together with a constant current drive are controlled to provide a constant current power supply to the LEDs 202.

A detail of one of the drivers 312 shows that each driver includes a controller 320 coupled to the master LED driver 310 and an internal LED power supply 322. The controller 320 may be implemented using logic hardware or a low cost microprocessor for example. Each internal LED power supply 322 comprises a DC-DC converter 324 and a constant current drive 326, which control power delivery to the strings of LEDs 202. The DC-DC converter 324 is supplied from the central or main power source 304, which is coupled to the drivers 312 by the supply rail 308.

The controller 320 receives the master driving signal (PWM signal) in order to determine the driving signal parameter (e.g., duty cycle or ON clock cycle count). The controller 320 is coupled to a memory 328 that contains an operational parameter such as one or more bin values for the LEDs 202 to which the driver 312 is coupled; or an adjustment parameter determined from the bin values and used to adjust the master driving signal for controlling the internal LED power supply 322. Thus, the internal LED power supply 322 is switched ON/OFF by the controller 320 according to both the driving signal parameter and the operational parameter of the LED.

In an alternative arrangement, the memory 328 containing the or: each operational parameter may be integrated into the master LED driver 110 or 310, and the operational parameters downloaded into the respective drivers 112 or 312.

Whilst the internal architecture of the driver 312 has been shown for only one driver for simplicity, the skilled person will appreciate that the same or a similar architecture will be used within each of the drivers. Similarly, whilst not shown in FIG. 2, each driver 112 will include a suitable controller (320), memory (328), and a constant current drive (326) though not a DC-DC converter 324. Also whilst a light sensor 210 has not been specifically shown in FIG. 3, it will be appreciated that one or more such light sensors could be used.

The embodiment of FIG. 2 has been described as using a central DC-DC converter 204 together with a serial interface 225, and the embodiment of FIG. 3 has been described as using drivers with integrated DC-DC converters 324 together with direct signal wires 306 carrying a master PWM signal rather than control messages as on the serial interface 206 of FIG. 2. However either DC-DC converter architecture 204 or 324 can be used with either driving signal parameter delivery architecture 206 or 306.

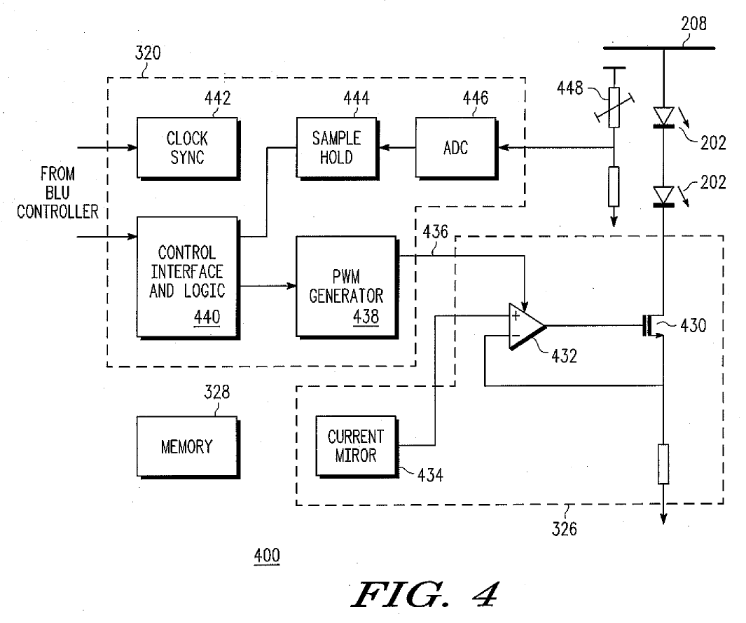

FIG. 4 illustrates in more detail a driver and LED string arrangement 400 according to an embodiment of the invention. The driver and LED string arrangement 400 comprises the controller 320, the constant current drive 326 and the memory 328 similar to those of the driver 312 illustrated in FIG. 3. In this embodiment however, the controller 320 receives a driving signal parameter via a control signal message from a suitable master driver, like the BLU controller 110 (FIG. 1), rather than a direct PWM signal.

A string of LEDs 202 is supplied from the DC-DC converter supply rail 208. The string of LEDs 202 is controlled or switched by a Field Effect Transistor (FET) 430 which in turn is controlled by the constant current drive 326. The FET 430 or other switch is driven by an analog driver 432 within the constant current drive 326 and having inputs from a current mirror 434 and the emitter of the switch or FET 430. This arrangement ensures a constant current through the string of LEDs 202.

The analog driver 432 is controlled or switched ON/OFF by a periodic drive signal 436, which is a PWM signal or other square wave drive signal generated by a PWM generator or other suitable periodic signal generator 438. The duty cycle of the PWM drive signal 436 is in turn controlled from a control interface and logic block or circuit 440.

The controller 320 also comprises a clock sync circuit 442 that receives a clock signal from the BLU controller or master driver 110, a sample and hold circuit 444 coupled to the control interface and logic block 440, and an analog-to-digital converter (ADC) 446 coupled to the sample and hold circuit 444. The ADC 446 receives an input from a temperature sensor 448 such as a temperature dependent resistor. Whilst a linear constant current drive 326 has been illustrated and described, alternative constant current drives could be used, for example any of the well known switching constant current drives.

The control interface and logic block 440 receives an input from the BLU controller or master LED driver 110, and in this embodiment incorporates a serial interface module for receiving a count or duration value. The count or duration value corresponds to the ON state of a notional master PWM driving signal, and represents the number of clock cycles of the ON state in each PWM cycle. As the number of clock cycles in the full PWM cycle (of ON and OFF) is known or predetermined, the number of clock cycles for the ON (or alternatively the OFF) state provides duty cycle information for the notional master PWM drive signal. The duty cycle information is the driving signal parameter in this embodiment. An alternative driving signal parameter or parameters could be provided, for example a duty cycle value from which the duration of the ON or OFF state could be determined. The control interface and logic block 440 also receives a temperature measurement from the temperature sensor 448, which is digitized and sampled by the ADC 446 and sample and hold circuit 444 as will be appreciated by those skilled in the art.

In an alternative arrangement such as that of FIG. 3, an actual master PWM driving signal is received from the master LED driver 310 at the control interface and logic block 440. A counter can be implemented within the logic block 440 in order to count the number of clock cycles of each ON (or OFF) state of the PWM signal. Again as the number of clock cycles in the full PWM cycle is predetermined, the duty cycle information can be determined.

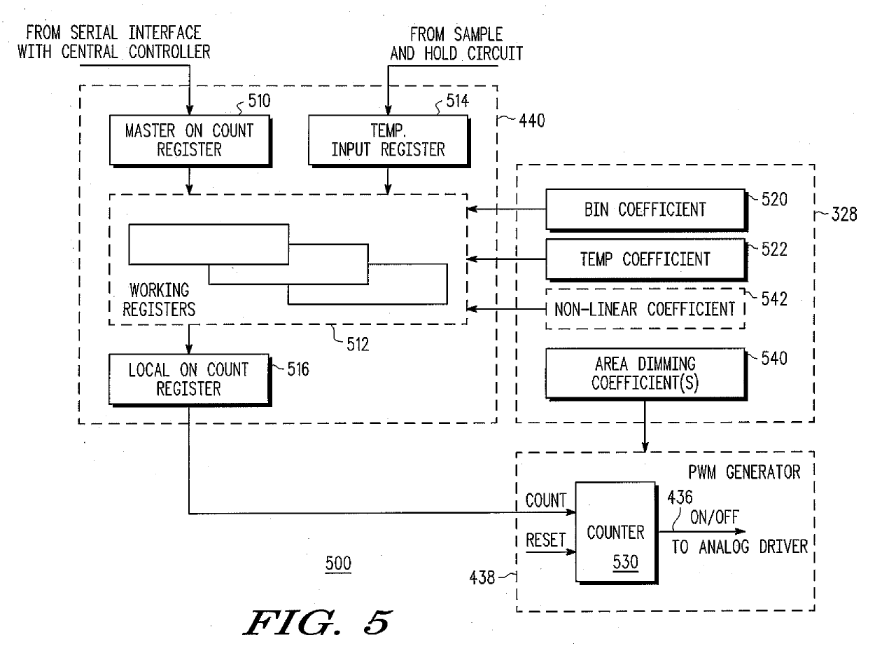

FIG. 5 illustrates in more detail part of a control interface and logic block and periodic driving signal generator arrangement 500 according to an embodiment of the invention. The arrangement 500 includes the memory 328, control interface and logic block 440, and PWM generator 438. The control interface and logic block 440 comprises a Master ON Count Register 510 that receives an input from the serial interface 206 from the BLU controller 110, a number of working registers 512 in order to carry out various mathematical operations, a Temperature Input Register 514 which receives an input from the sample and hold circuit 444 (FIG. 4), and a Local ON Count Register 516. The control interface and logic block 440 is also coupled to the memory 328, which may be a FLASH or other non-volatile storage that stores a Bin Coefficient 520 and a Temperature Coefficient 522. This data, actual bin values or other operational parameters of the LED may alternatively by stored in a memory in the master LED driver or the BLU controller 110 and downloaded to the LED driver 112, for example into volatile memory at startup. The Bin Coefficient 520 and the Temperature Coefficient 522 are pre-programmed or stored in the memory 328 and are dependent on the bin values of the LEDs (202) which the driver will be driving. Typically the Bin Coefficient 520 is added to the value of the Master ON Count Register 510 and the result entered into the Local ON Count Register 516. The Bin Coefficient may be negative if for example the bin values of the LEDs (202) correspond to a high light output, and positive if the bin values of the LEDs (202) correspond to a low light output. Such positive and negative values have the effect of decreasing or increasing the ON time (duty cycle) of the periodic drive signal 436 compared with the master driving signal 118 and according to an operational parameter of the LEDs 202—in this example the brightness or light output bin value. This effectively tunes the master driving signal to produce a local or regional periodic driving signal that compensates or adjusts for different bin values for the local or regional LEDs 202.

Additional Bin Coefficients (not shown) may also be used to adjust the value to be entered into the Local ON Count Register 516, for example where the LED's 202 of the local regional array of LEDs 108 have different color and forward voltage bin values compared with the nominal bin values for which the master driving signal was generated. The bin values correspond to a narrow range of characteristic values for brightness, color, and forward voltage characteristics of the LEDs in each respective regional array 108 of LEDs 202 to be driven by the driver.

The value in the Temperature Input Register 514 is multiplied by the Temperature Coefficient 522 in order to produce an intermediate value that is added to the Local ON Duration Register 516. As is known, the light output of an LED changes with temperature even when a constant current is applied. In order to maintain good uniformity of light output from the BLU 106, the light output from the LEDs 202 needs to be adjusted in order to compensate for this effect. By adjusting the count value in the Local ON Count Register 516 based on the measured temperature, the duty cycle of the PWM drive signal 436 is adjusted to compensate for changes in measured temperature of the LEDs 202, for example as they heat up with operation.

The value of the or each Bin Coefficient 520 and the Temperature Coefficient 522 can be determined experimentally for LEDs of each bin value(s). This can be achieved for example using light output sensors and manually adjusting the duty cycle of the driving signal of the LED(s) in order to achieve uniformity of light output. The change in duty cycle or ON clock cycle count can then be determined and used for LEDs having the respective change in bin value. A similar process can be performed for changes in temperature.

The PWM or periodic driving signal generator 438 comprises a counter 530 which receives a count value from the Local ON Count Register 516. The counter 530 is reset with this count value at the start of each PWM cycle. The duration or number of clock cycle counts for each full PWM cycle is predetermined and can be used to trigger each reset of the counter 530. Upon reset, the output of the counter 530 is configured HIGH or ON, and the counter 530 decrements with each clock cycle. Upon counting down to zero, the counter output switches to LOW or OFF until the reset is triggered and again at the end of the PWM cycle. The ON/OFF output of the counter 530 is used as the periodic driving signal 436 to control the analog driver 432 (FIG. 4), which in turn provides a periodic driving signal to switch the LEDs 202 ON/OFF. Thus the LEDs 202 in the region 108 driven by the driver 112 are switched on and off with a duty cycle according to the value (count) of the Local ON Count Register 516.

By using drivers 112 each comprising one or more Bin Coefficient 520 or other operational parameters associated with the LEDs they will be driving, the periodic driving signal 436 from the respective drivers can be tuned from a driving signal parameter from a master driving signal or even directly from an LCD controller 104 in order to drive LEDs having different bin values. This allows different regions 108 of a larger BLU 106 to have LED having different bin values and still be controlled by the same driving signal parameter. This relaxed binning requirement reduces the cost of manufacturing the BLU 106. In addition the light output of a single region of LEDs can be tuned based on the temperature associated with that region rather than a temperature associated with the entire BLU for example.

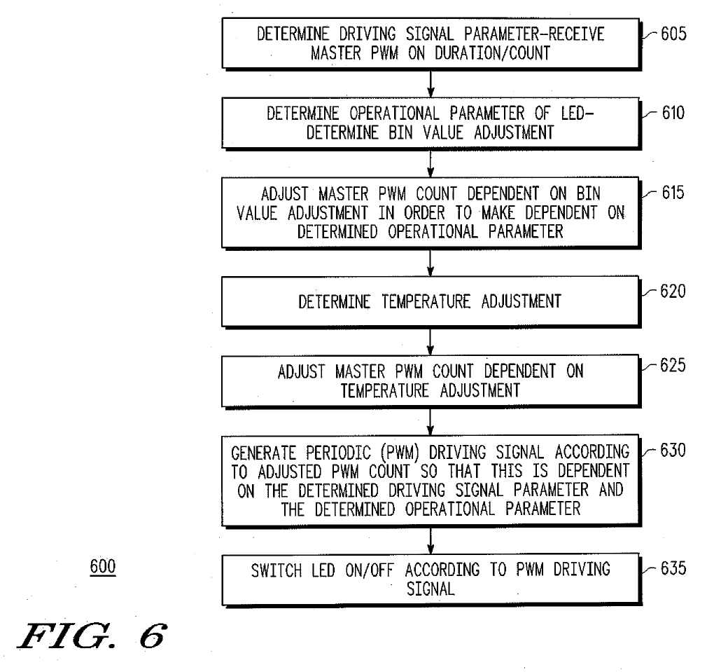

FIG. 6 illustrates a method of using a master PWM driving signal for LEDs having a nominal operational parameter (e.g., brightness bin value) to generate a PWM or other periodic driving signal for LEDs in a regional array having a different operational parameter. The method 600 receives at step 605 a master PWM signal ON count or other driving signal parameter for the LEDs of the regional array. In an embodiment of the invention, the driving signal parameter may be sent from a master LED driver or BLU controller to one or more drivers on a serial interface, or embodied in a master driving signal such as a master PWM and interpreted by each driver as a driving signal parameter. At step 610, a bin value adjustment or other operation parameter of the LEDs that it will be driving is determined. For example the LEDs may be specified according to a different bin value (e.g., range of lumen light output) from that used for the master PWM or driving signal parameter. The method then adjusts the PWM signal ON count or other duty cycle related parameter of the master signal parameter in order to tune this to the local driver's LEDS at step 615. For example, an experimentally determined bin co-efficient is added to the master PWM signal ON count in order to lengthen the ON duration of the PWM signal. The method then determines a temperature adjustment at step 620 by receiving a temperature measurement from a temperature sensor proximate the LEDs to be driven by the or each driver, and processing the temperature measurement with a temperature co-efficient. The temperature adjustment is then used to further adjust the Master ON count register (510) value for example, in order to obtain the adjusted value in the Local ON count register (516) at step 625. The Local ON count value is then used to generate a PWM driving signal at step 630, which is dependent on both the driving signal parameter (510) and the operational parameter (520) of the regional or local LEDs. The generated periodic driving signal is then used to switch the local LEDs on and off using the adjusted duty cycle, at step 635.

Although PWM driving signals have been described in the embodiments, other types of square waves or other periodic signals could alternatively be used to drive the local LEDs.

Although the Master ON Count and Local ON Count variables have been used in the described embodiments to tune the periodic driving signal to local LED bin values, alternative operational parameters for the local LEDs could be used; for example an OFF count, a duty cycle value, and an average power value.

Similarly various alternative LED power sources, serial buses, constant current drivers, and temperature sensors could be used where appropriate as would be appreciated by those skilled in the art.

The described embodiments could be used in additional applications beyond BLU's, for example in TV walls or other modular display systems.

The local memory 328 (FIGS. 3 and 4) may also be used to store data relating to the non-linear performance of the analog driver 432 in order to compensate for non-linear performance in each respective driver 112 as described in more detail below.

Advantageously, the PWM driving signal is synchronized with a clock signal from the master LED driver 110, 310. All of the drivers 112, 312 may be synchronized to the same clock signal in order to synchronize the leading edge of each PWM driving signal. This is useful when using a flashing BLU in order to reduce motion blur on the LCD unit 102.

Advantageously, the embodiments may be used with RGB edge triggering technology in which the Red, Green and Blue LEDs 202 have the leading edge of their respective PWM driving signals. This reduces the instantaneous in-rush current of the LED array of the BLU 106 and hence the associated EMI.

Whilst the driver architecture has been described with respect to a master LED driver 110 and a plurality of (local) drivers, the driver architecture may be implemented in a single device such as an integrated circuit (IC) that provides multiple (local) periodic driving signals to different groups or regions of LEDs having a common operational parameter. Thus, the single device drives one or more regions of the BLU, where each driven region has LEDs having different common operational parameters such as bin values.

In another embodiment, and referring to FIGS. 1, 3, 4 and 5, each driver 112, 306 may include two or more periodic signal generators 438. These signal generators 438 may be utilized in order to implement different dimming parameters or levels in the different areas 114 of each region 108 of the BLU 106. For example a BLU region 108 driven by a driver 112, 306 may have two different areas 114 or sub-regions of LEDs having the same operational parameters (e.g., bin values), but where each area 114 of the region 108 is required to have a different brightness level. In this case the two areas 114 can use a periodic driving signal 436 provided from different PWM generators 438 within the same driver 112, 306. Each periodic driving signal 438 will drive respective constant current drives 326 coupled to the LEDs of each respective area 114 of the BLU region 108. The two different PWM generators 438 will generate periodic driving signals with different duty cycles, though these duty cycles will both be dependent on the driving signal parameter received by the control interface and logic block 440. In order to implement this, one or more area dimming coefficients 540 or other dimming parameters stored in the memory 328 may be used by respective PWM generators 438 in order to further adjust the duty cycle of their respective periodic driving signals 436. This may be implemented by adding the respective area dimming coefficient 540 to the Local ON Count register 516 output received by each PWM generator 438. A suitable adding register (not shown) can be employed within each respective PWM generator 438 and with an output to the count input of the counter 530.

In a further alternative, regional dimming may be implemented using the above described multiple periodic signal generator (438) approach in which instead of using different driving signal parameters for the drivers of each region 108, a suitable dimming signal corresponding to the area dimming coefficients 540 could be used.

Similar architectures could be employed in a single driver device (integrating the master LED driver and driver functions). For example, each multiple (local) periodic driving signal could be further divided into area periodic driving signals for respective areas of the regions in order to implement the area 114 based dimming within each region 108. Similarly dimming signals could be used instead of different signal parameters in order to implement regional dimming.

In another embodiment, and referring to FIGS. 4 and 5, the duty cycle of the (local) periodic drive signal 436 may be further adjusted in order to compensate for a non-linear parameter of the driver and in particular the constant current drives 326. Non-linear performance can be an issue particularly in the linear constant current drive 326 using an analog driver 432. The analog driver's output is not directly proportional to its output over its entire output range—in particular the highest and lowest output voltages of its range. Thus, for example, when the duty cycle of the drive signal 436 is 10%, in order to obtain the correct output voltage from the analog driver 432, an actual input signal (436) duty cycle of say 12% might be required. Similarly where the input (periodic driving) signal (436) duty cycle nominally is above 90%, adjustment to this input signal (436) may be required in order to provide the correct output voltage from the analog driver 432. For example, a periodic driving signal having a 92% duty cycle should in fact be adjusted to 91% in order to compensate for the non-linear performance of the analog driver 432 at the extremes of its output voltage range.

In order to implement this, an optional non-linear adjustment coefficient(s) 542 or other non-linear parameter of the driver may be stored in the memory 328 alongside the bin coefficient 520. A non-linear adjustment coefficient 542 may be required for each of a number of duty cycle values, for example for each duty cycle percentage between 0 and 10% and between 90 and 100%. Suitable arrangements of the registers and logic within the logic and control block 440 could be used to determine whether one of these duty cycles (Local ON Count) is present in the Local ON Count register 516, and if so to adjust this value according to the appropriate non-linear adjustment coefficient 542 before outputting to the PWM generator 438. These non-linear adjustment coefficients may be determined experimentally as will be appreciated by those skilled in the art, and used to compensate for this non-linear aspect or parameter of the analog driver 432 and hence the driver 312.

In a further alternative, this compensation for non-linear performance of the driver may be used without adjustment of the driving signal parameter for different LED operational parameters.

Whilst LEDs have been described, equivalent semiconductor light emitting diodes could also be controlled in a similar manner to that described, or have a similar driver.

The skilled person will recognise that the above-described apparatus and methods may be embodied as processor control code, for example on a carrier medium such as a disk, CD or DVD-ROM, programmed memory such as read only memory (firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A method of driving an LED, the method comprising:
determining an operational parameter of the LED;
determining a driving signal parameter for the LED;
generating a periodic driving signal for driving the LED, wherein the generated periodic driving signal has a duty cycle dependent on the determined driving signal parameter and the determined operational parameter of the LED.

2. The method of driving an LED according to claim 1, wherein the operational parameter corresponds to a range of characteristic values of a characteristic of the LED, the characteristic of the LED being one or a combination of wavelength of light output, brightness of light output, and LED forward voltage.

3. The method of driving an LED according to claim 2, wherein the range of characteristic values of the characteristic of the LED corresponds to a bin value.

4. The method of driving an LED according to claim 1, wherein the duty cycle of the generated periodic driving signal is also dependent on a second determined operational parameter that corresponds to a measured temperature value associated with the LED.

5. The method of driving an LED according to claim 1, wherein the determined driving signal parameter for the LED is dependent on a master driving signal that is not dependent on the determined operational parameter of the LED, the determined driving signal parameter being adjusted dependent on the determined operational parameter in order to generate the periodic driving signal.

6. The method of driving an LED according to claim 5, wherein determining the driving signal parameter comprises receiving a count or duration value for one of two states of the master driving signal.

7. The method of driving an LED according to claim 6, wherein receiving the count or duration value comprises counting a number of clock cycles during the one of two states of the master periodic driving signal, the master periodic driving signal being a pulse width modulation signal having a cycle of a predetermined number of clock cycles.

8. The method of driving an LED according to claim 1, wherein determining the driving signal parameter comprises receiving a control signal message containing the driving signal parameter.

9. The method of driving an LED according to claim 1, further comprising:
determining an operational parameter for a second LED;
generating a second periodic driving signal for driving the second LED, the generated second periodic driving signal having a duty cycle dependent on the determined driving signal parameter and the determined second operational parameter of the LED.

10. The method of driving an LED according to claim 9, wherein the driving signal parameter corresponds to the duty cycle of a master pulse width modulation signal, and generating the first and second periodic driving signals comprises adjusting the duty cycles of the master PWM driving signal according to the operational parameter of the first and second LEDs in order to generate the respective first and second periodic driving signals.

11. A driver for driving an LED, the driver comprising:
a memory that stores an operational parameter of the LED;
a controller coupled to the memory and arranged to determine a driving signal parameter for the LED; and
a periodic signal generator coupled to the controller and arranged to control a switch for switching the LED with a generated periodic driving signal, the periodic signal generator arranged to adjust a duty cycle of the generated periodic driving signal dependent on the determined driving signal parameter and the stored operational parameter of the LED.

12. A driver architecture for driving an array of LEDs, the array of LEDs being arranged into a plurality of regional arrays of LEDs each having a common LED operational parameter, the driver architecture comprising:
one or more controllers arranged to determine a driving signal parameter for each regional array of LEDs;
a memory coupled to the one or more controllers that stores each common LED operational parameter for each respective regional array of LEDs; and
a periodic signal generator coupled to the controller for each regional array of LEDs, each periodic signal generator arranged to generate a periodic driving signal for the respective regional array of LEDs, wherein a duty cycle of each periodic driving signal is controlled to be dependent on the respective LED operational parameter for the respective regional array of LEDs and the respective driving signal parameter.

13. The driver architecture according to claim 12, further comprising:
a plurality of drivers for driving a respective regional array of LEDs, each driver comprising a said controller and a said periodic signal generator;
a master LED driver coupled to the plurality of said drivers, wherein the master LED driver generates the or each respective driving signal parameter for each regional array of LEDs.

14. The driver architecture according to claim 13, wherein the master LED driver generates one or more master periodic driving signals according to the or each respective driving signal parameter and each said driver determines the respective driving signal parameter from the or the respective master periodic driving signal.

15. The driver architecture according to claim 14, wherein each periodic driving signal is synchronized with the master periodic driving signal.

16. The driver architecture according to claim 12, wherein the duty cycle of a said periodic driving signal is further controlled to be dependent on a non-linear parameter of the respective driver.

17. The driver architecture according to claim 12, wherein a said driver further comprises a second periodic signal generator, the second periodic signal generator generating a second periodic driving signal for a respective area of the respective regional array of LEDs, the duty cycle of each second periodic driving signal being controlled to be dependent on the respective LED operational parameter for the respective regional array of LEDs, the respective driving signal parameter and a dimming parameter for the respective area of the regional array of LEDs.

18. The driver architecture according to claim 12, wherein the array of LEDs form a backlighting unit for a liquid crystal display.

19. The driver architecture according to claim 12, wherein the driver further generates different driving signal parameters for each regional array of LEDs in order to implement regional dimming of the regional arrays of LEDs.

20. The driver architecture according to claim 13, wherein the drivers and the master LED driver are integrated into a single integrated circuit.
